(19) United States
(12) Patent Application Publication
(10) Pub. No.: US 2006/0077315 A1
(43) Pub. Date: Apr. 13, 2006

(54) Backlight unit and liquid crystal display device using the same

(75) Inventors: Ji-Young Ahn, Annyang-si (KR); Kyo-Seop Choo, Suwon-si (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/168,165

(22) Filed: Jun. 28, 2005

(30) Foreign Application Priority Data
Oct. 12, 2004 (KR) 2004-0081198

(51) Int. Cl. G02F 1/1335

(52) U.S. Cl. 349/61

(57) ABSTRACT

A backlight unit includes: a first lamp group including at least one lamp emitting light corresponding to at least one of red, green and blue colors; and a second lamp group including at least one lamp emitting light corresponding to at least one color other than the colors red, green and blue.

The present invention claims the benefit of Korean Patent Application No. 2004-81198, filed in Korea on Oct. 12, 2004, which is hereby incorporated by reference.

### BACKGROUND OF THE INVENTION

1. Field of the Invention

The present invention relates to a display device, and more particularly, to a backlight unit and a liquid crystal display device using the backlight unit to improve color saturation.

2. Discussion of the Related Art

As the information age progresses, flat panel display (FPD) devices having light weight, thin profile, and low power consumption characteristics are being developed and commonly used as a substitute for cathode ray tube (CRT) devices. Generally, display devices may be classified according to their ability for self-emission, and the classification may include emissive display devices and non-emissive display devices. The emissive display devices display images by taking advantage of their ability to self-emit light, and the non-emissive display devices require a light source since they do not emit light by themselves. For example, plasma display panel (PDP) devices, field emission display (FED) devices, and electroluminescent display (ELD) devices are commonly used as emissive display devices. Liquid crystal display (LCD) devices may be categorized as non-emissive display devices and are commonly used in notebook and desktop computers because of their high resolution, capability of displaying colored images, and high quality image display.

An LCD module of the LCD device includes an LCD panel for displaying images, wherein the LCD panel is a non-emissive-type display device, and hence an additional light source is required. Thus, a backlight unit is located under the LCD panel, wherein the LCD device displays images using light produced by the backlight unit. For example, a cold cathode fluorescent lamp (CCFL) is generally utilized as the backlight unit lamp. The lighting principle of the CCFL is similar to that of a hot cathode fluorescent lamp, but the CCFL emits light by electron emission using an electric field applied to an electrode while the hot cathode fluorescent lamp emits light by electron emission using heat. Therefore, the amount of the generation of heat for the CCFL is substantially very small.

FIG. 1 is a schematic view illustrating a cold cathode fluorescent lamp (CCFL) of a backlight unit according to the related art.

In FIG. 1, a CCFL comprises a glass tube 10 including gas mixtures having Mercury (Hg), argon (Ar), neon (Ne) and the like, and a phosphor layer 11 from a phosphor coating on an inner wall of the glass tube 10. Further, a sealing unit 12 is located at both end portions of the glass tube 10 and prevents the gas mixtures from leaking outside. A lead line 14 extends from an outer portion of the glass tube 10 to an inner portion of the glass tube 10 via the sealing unit 12. An electrode 16 is connected to an end portion of the lead line 14 in both inner portions of the glass tube 10, and a cover case 18 covers the lead line 14 from the sealing unit 12 to the electrode 16.

The CCFL has the property that the diameter of the glass tube 10 is very thin such as a few millimeters. Meanwhile, when a high voltage is applied to both end portions of the electrode 16 through the lead line 14, an ionization reaction with Hg occurs by electron emission from both end portions of the electrode 16. Hg is excited by the ionization reaction, and hence high frequency energy (ultra violet) is generated. Accordingly, the phosphor layer 11 acts as a wavelength transformer such that a short wavelength of ultra violet is changed into the longer wavelength of a visible ray. Here, an energy difference due to the wavelength transformation is consumed by heat.

The electrode 16 includes Tungsten (W), Nickel (Ni) and Alumina (Al₂O₃), wherein Ni is generally utilized because its amount of Hg reduction is lower, and hence a sectional area of the electrode 16 made of Ni can be easily modified.

In addition, phosphor of the phosphor layer 11 includes rare earth element material such as Yttrium, Cerium (Ce), and Terbium (Tb). For example, a white light based tri-phosphor for the LCD device is usually utilized. The tri-phosphor corresponds to a mixing of the phosphors that emit light corresponding to red, green and blue colors.

FIG. 2 is a schematic view showing a distribution of wavelengths with respect to red, green and blue colors of a tri-phosphor lamp for a backlight unit according to the related art.

In FIG. 2, a tri-phosphor lamp has wavelengths with respect to red, green and blue colors R, G and B, wherein each of the red, green and blue colors R, G and B has a respective spectral wavelength peak. To improve color saturation in the distribution with respect to tri-phosphor formation, gas or phosphor capable of representing a wavelength peak of a relevant color should be combined in order to add wavelength peaks for colors other than red, green and blue R, G and B, such as yellow or cyan colors Y and C, as shown in FIGS. 3A and 3B, respectively.

However, it is difficult to obtain a desired wavelength peak for the relevant color by ensuring that the proper gas or phosphor is discovered or is developed by combining either various gases or various phosphor.

### SUMMARY OF THE INVENTION

Accordingly, the present invention is directed to a backlight unit and a liquid crystal display device using a backlight unit that substantially obviates one or more of the problems due to limitations and disadvantages of the related art.

An object of the present invention is to provide a backlight unit that can improve color saturation.

Another object of the present invention is to provide a LCD device using a backlight unit that can improve color saturation.

Additional features and advantages of the invention will be set forth in the description which follows, and will be apparent from the description, or may be learned by practice of the invention. The objectives and other advantages of the invention will be realized and attained by the structure particularly pointed out in the written description and claims hereof, as well as the appended drawings.

To achieve these and other advantages and in accordance with the purpose of the present invention, as embodied and broadly described, a backlight unit includes: a first lamp group including at least one lamp emitting light corresponding to at least one of red, green and blue colors; and a second lamp group including at least one lamp emitting light corresponding to at least one color other than red, green or blue colors.

In another aspect, a liquid crystal display device using a backlight unit includes: an image display unit having a plurality of pixel regions; a backlight unit under the image display unit including: a first lamp group including at least one lamp emitting light corresponding to at least one of red, green and blue colors; and a second lamp group including at least one lamp emitting light corresponding to at least one color other than red, green or blue colors; and a driving circuit unit controlling the backlight unit and transmitting data to the image display unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic view illustrating a cold cathode fluorescent lamp (CCFL) of a backlight unit according to the related art.

FIG. 2 is a schematic view showing a distribution of wavelengths with respect to red, green and blue colors of a tri-phosphor lamp for a backlight unit according to the related art.

FIGS. 3A and 3B are schematic views showing a distribution of a first wavelength peak group with respect to each of the red, green, and blue colors, but further including a distribution of a second wavelength peak group with respect to yellow and cyan colors according to the related art.

FIG. 4 is a schematic view illustrating an organization of a backlight unit to improve color saturation according to the present invention.

FIGS. 5A and 5B are schematic views illustrating a combination of an organization of a backlight unit according to the present invention.

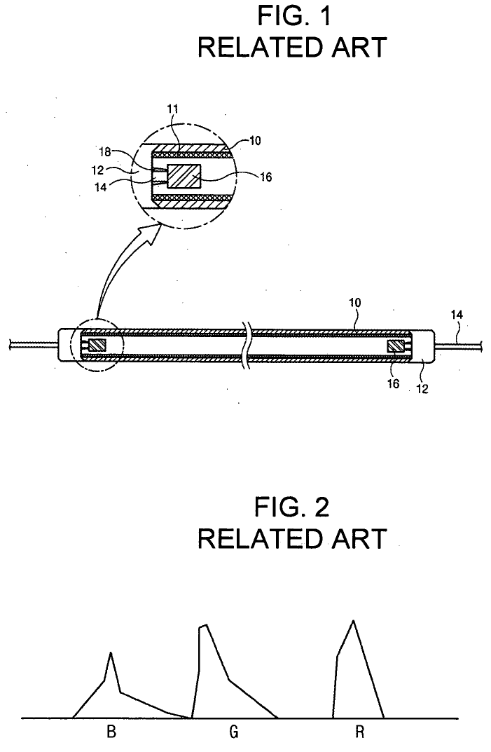

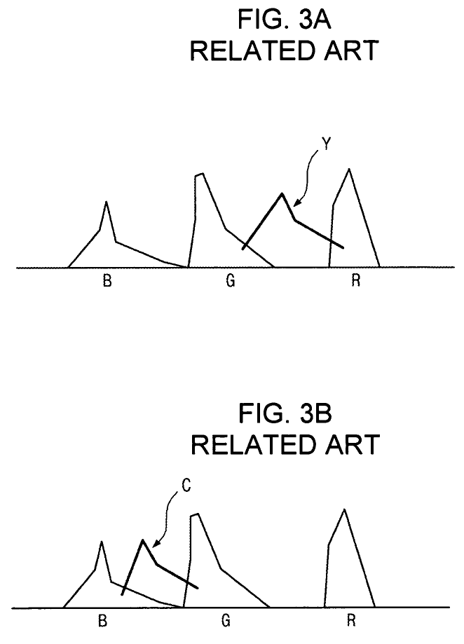

### DETAILED DESCRIPTION OF THE ILLUSTRATED EMBODIMENTS

Reference will now be made in detail to the illustrated embodiments of the present invention, examples of which are illustrated in the accompanying drawings.

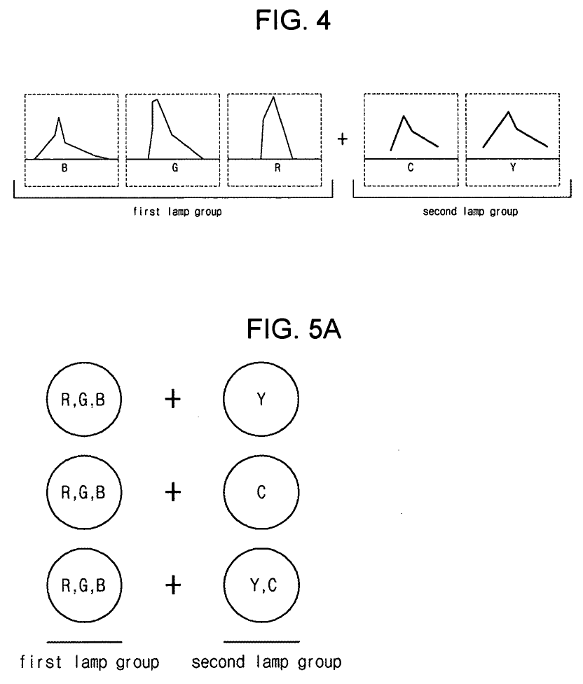

FIG. 4 is a schematic view illustrating an organization of a backlight unit to improve color saturation according to the present invention.

In FIG. 4, a backlight unit according to the present invention utilizes a first lamp group that emits light corresponding to at least one of red, green and blue colors R, G and B and further includes a second lamp group that emits light corresponding to at least one color other than red, green and blue colors R, G and B, thereby overcoming the limitation of color saturation.

As shown in FIG. 4, the first lamp group represents red, green and blue colors R, G and B, and the second lamp group represents yellow and cyan colors Y and C. In other words, the first lamp group includes wavelength peaks with respect to red, green and blue colors R, G and B, and the second lamp group includes wavelength peaks with respect to yellow and cyan Y and C, respectively. Although not shown, the second lamp group may include a magenta color as well as yellow and cyan colors Y and C.

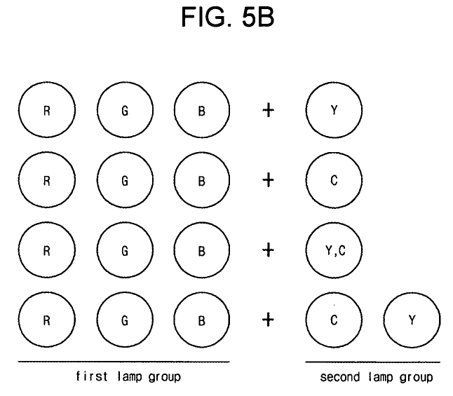

FIGS. 5A and 5B are schematic views illustrating a combination of the organization of a backlight unit according to the present invention.

In FIG. 5A, a first lamp group includes one lamp representing all of red, green and blue colors R, G and B, and a second lamp group includes one lamp that emits light corresponding to at least one of yellow and cyan colors Y and C. The use of the colors yellow and cyan is for explanatory purposes, but the second lamp group could include any color other than the colors of red, green and blue.

Alternatively, in FIG. 5B, a first lamp group includes three lamps that emit light corresponding to red, green and blue colors R, G and B, respectively. A second lamp group includes at least one lamp that emits light corresponding to at least one of yellow and cyan colors Y and C, or a combination thereof. More specifically, with regard to the third case shown, the second lamp group includes one lamp that emits light representing all of yellow and cyan colors Y and C. With regard to the fourth case shown, the second lamp group includes two lamps that emit light representing yellow and cyan colors Y and C, respectively.

That is, the first lamp group includes at least one lamp emitting light corresponding to at least one of red, green and blue colors R, G and B, and the second lamp group includes at least one lamp emitting light corresponding to at least one color other than red, green and blue colors R, G and B, wherein the colors of the first lamp group are different from the colors of the second lamp group. FIG. 5B shows the second lamp group with the colors yellow and cyan, however, the second lamp group comprises at least one color that is not red, green or blue.

The backlight unit according to the present invention may be applied to a liquid crystal display (LCD) device.

More specifically, although not shown, the LCD device may include an image display unit having a plurality of pixel regions, a backlight unit under the image display unit including a first lamp group including at least one lamp emitting light corresponding to at least one of red, green and blue colors R, G and B, and a second lamp group including at least one lamp emitting light corresponding to at least one color other than red, green and blue colors R, G and B, and a driving circuit unit controlling the backlight unit and transmitting data to the image display unit.

The backlight unit and the LCD device using the same according to the present invention can improve color saturation by adding another lamp group as well as one lamp group that emits light representing red, green and blue colors. The other lamp group represents at least one color other than red, green and blue. Therefore, colors having a higher purity can be obtained in the LCD according to the present invention.

It will be apparent to those skilled in the art that various modifications and other variations can be made in a backlight unit and a liquid crystal display device using a backlight unit of the present invention without departing from the spirit or scope of the invention. Thus, it is intended that the present invention cover the modifications and variations of this invention provided they come within the scope of the appended claims and their equivalents.

What is claimed is:

1. A backlight unit, comprising:
a first lamp group including at least one lamp emitting light corresponding to at least one of the colors red, green and blue; and
a second lamp group including at least one lamp emitting light corresponding to at least one color other than red, green and blue.

2. The backlight unit according to claim 1, wherein the first lamp group includes one lamp.

3. The backlight unit according to claim 2, wherein the one lamp of the first lamp group represents all of the colors red, green and blue.

4. The backlight unit according to claim 1, wherein the first lamp group includes three lamps.

5. The backlight unit according to claim 4, wherein the three lamps of the first lamp group each emit one colors of light corresponding to red, green and blue, respectively.

6. The backlight unit according to claim 1, wherein each color of the first lamp group is different from each color of the second lamp group.

7. The backlight unit according to claim 1, wherein the at least one color of the second lamp group includes at least one of yellow, cyan and magenta colors.

8. A liquid crystal display device using a backlight unit, comprising:
an image display unit having a plurality of pixel regions;
a backlight unit under the image display unit comprising:
a first lamp group including at least one lamp emitting light corresponding to at least one of red, green and blue colors; and
a second lamp group including at least one lamp emitting light corresponding to at least one color other than red, green and blue; and
a driving circuit unit controlling the backlight unit and transmitting data to the image display unit.

9. The device according to claim 8, wherein the first lamp group includes one lamp.

10. The device according to claim 9, wherein the one lamp of the first lamp group represents all of the colors red, green and blue.

11. The device according to claim 8, wherein the first lamp group includes three lamps.

12. The device according to claim 11, wherein the three lamps of the first lamp group each emit one color of light corresponding to red, green and blue, respectively.

13. The device according to claim 8, wherein each color of the first lamp group is different from each color of the second lamp group.

14. The device according to claim 8, wherein the at least one color of the second lamp group includes at least one of yellow, cyan and magenta colors.

15. A method for providing a light source for a backlight unit comprising:
emitting light from at least one lamp of a first lamp group corresponding to at least one of the colors red, green and blue;
emitting light from at least one lamp of a second lamp group corresponding to at least one color other than the colors red, green and blue.

16. The method according to claim 15, wherein the first lamp group includes one lamp.

17. The method according to claim 16, wherein the one lamp of the first lamp group represents all of the colors red, green and blue.

18. The method according to claim 15, wherein the first lamp group includes three lamps.

19. The method according to claim 18, wherein the three lamps of the first lamp group each emit one color of light corresponding to red, green and blue, respectively.

20. The method according to claim 15, wherein each color of the first lamp group is different from each color of the second lamp group.

21. The method according to claim 15, wherein the at least one color of the second lamp group includes at least one of yellow, cyan and magenta colors.

22. A backlight unit, comprising:
a first lamp group including at least one lamp emitting light corresponding to a first group of colors; and
a second lamp group including at least one lamp emitting light corresponding to a second group of colors;
wherein the colors in the first group are different from the colors in the second group.

23. The backlight unit according to claim 22, wherein the first group of colors includes at least one of red, green and blue.

24. The backlight unit according to claim 22, wherein the second group of colors includes colors other than red, green and blue.

25. The backlight unit according to claim 22, wherein the first lamp group includes one lamp.

26. The backlight unit according to claim 25, wherein the one lamp of the first lamp group represents all of the colors red, green and blue.

27. The backlight unit according to claim 22, wherein the first lamp group includes three lamps.

28. The backlight unit according to claim 27, wherein the three lamps of the first lamp group each emit one color of light corresponding to red, green and blue, respectively.

29. The backlight unit according to claim 22, wherein the second group of colors includes at least one of yellow, cyan and magenta colors.
